(19) United States
(12) Patent Application Publication
(10) Pub. No.: US 2008/0121656 A1
(43) Pub. Date: May 29, 2008

(54) SPREADABLE FOOD DISPENSER FOR TWO OR MORE FOODS

(76) Inventors: Francis Kiss deVirag, Kirtland Hills, OH (US); Alexander Sterling Wise, Mentor, OH (US); Ileen Rosner, Novelty, OH (US); Jonathan Rosner, Novelty, OH (US)

Correspondence Address: AMIN, TUROCY & CALVIN, LLP, 1900 EAST 9TH STREET, NATIONAL CITY CENTER, 24TH FLOOR,, CLEVELAND, OH, 44114, US

(21) Appl. No.: 11/847,248

(22) Filed: Aug. 29, 2007

Related U.S. Application Data
(60) Provisional application No. 60/823,860, filed on Aug. 29, 2006.

(51) Int. Cl. B67D 5/52; B65D 88/54; G01F 11/00

(52) U.S. Cl. 222/135; 222/333; 222/390

(57) ABSTRACT

A dispenser for spreadable foodstuffs or spreadable non-food substances allowing for at least two foodstuffs or non-food substances to be stored separately and individual dispensed. Dispenser also allows for foodstuffs or non-food substances to be spread in a knife-like manner without the use of any additional utensils that are not part of the packaging. Dispenser is easily refilled with replaceable cartridges and designed to keep contents away from air as contents are dispensed.

### TECHNICAL FIELD

The present invention generally relates to a device for dispensing food products and other spreadable non-food substances. In particular, the present invention relates to dispensing spreadable foodstuffs or other spreadable non-food substances in specific metered amounts ready for spreading.

### BACKGROUND

The vast majority of packaging of spreadable foodstuffs lack any functionality to allow contents to be used directly from the packaging. The packaging for spreadable foodstuffs such as ketchup, mustard, cream cheese, peanut putter, jelly, etc. typically require a knife or other utensil not part of the food packaging to remove the foodstuff from a container and/or achieve spreading the foodstuff as desired. Even containers that allow for squeezing the foodstuff contained therein directly out of the packaging often still require a utensil not part of the food packaging to evenly spread the foodstuff. Such containers also often do not dispense foodstuffs easily as the void space of the container increases as foodstuff is consumed. Often the contents may splatter or take a significant amount of time to flow due to a large volume of air in the container. Air being introduced to the container during the products use also negatively affects product freshness.

Traditional food containers are also typically challenging for children, elderly, diasabled, or physically challenged individuals to use. Such containers also require utensils to be washed after every minor use of the product, which is a particular inconvenience during such activities as traveling, picnics, or other occasions where typical kitchen amenities are not present in addition to individuals who do not own a dishwasher.

Additionally, spreadable foodstuffs are often difficult if not impossible to measure via traditional means such as measuring cups. Very viscous foodstuffs such as peanut butter and cream cheese are difficult to measure with measuring cups since an accurate measurement may only be achieved by packing the product to remove any air left in the measuring cup. Even after an accurate measure is taken, it is extremely difficult to quantitatively transfer the measured product out from the measuring cup. A solution to accurate measurement and use of spreadable foodstuffs is particularly pertinent in restaurant settings where consistency is important. An accurate way to dispense spreadable foodstuffs is also important in home-settings for portion control and dieters.

The invention is also designed for use with a variety of non-food semi-solid or gelatinous substances. These substances include but are not limited to toothpaste, shoe polish, paints, cosmetics, thick oils, topical medications, and emollients. The typical containers for these substances are often the same and have the same limitations as those used for foodstuffs. These main limitations being the need for an additional utensils to remove and use the substance from the container, air being introduced to the containers over time as the substance is used, difficulty of use for children or individuals with physical limitations, and difficulty in measuring with measuring cups.

### SUMMARY

The following presents a simplified summary of the invention in order to provide a basic understanding of some aspects of the invention. This summary is not an extensive overview of the invention. It is intended to neither identify key or critical elements of the invention nor delineate the scope of the invention. Rather, the sole purpose of this summary is to present some concepts of the invention in a simplified form as a prelude to the more detailed description that is presented hereinafter.

The subject invention provides for spreadable foodstuffs to be packaged in a container that has a means for spreading the contained foodstuff in a knife-like manner without the use of any additional utensils not part of the food packaging as well as providing for a packaging of two different foodstuffs that may be dispensed independently from each other.

One aspect of the invention relates to providing a convenient means of storing two spreadable foodstuffs or other spreadable non-food substance in a single container and allowing each to be dispensed separately. Another aspect of the invention relates to providing a convenient means of use of spreadable foodstuffs or non-food substances for those traveling, picnics or other outdoor activities, or other times when traditional home amenities are not available.

Yet another aspect of the invention relates to providing a means for restaurants and caterers to dispense and use spreadable foodstuffs with greater speed. Still yet another aspect of the invention relates to providing a packaging that keeps contents fresher once seal on package has been broken and is in use.

Another aspect of the invention relates to minimizing waste of foodstuffs and non-food substances compared to traditional packaging. An additional aspect of the invention is to provide a packaging that is less disposable than traditional packaging and therefore suitable for targeted and affinity marketing in a more affective manner.

To the accomplishment of the foregoing and related ends, the invention comprises the features hereinafter fully described and particularly pointed out in the claims. The following description and the annexed drawings set forth in detail certain illustrative aspects and implementations of the invention. These are indicative, however, of but a few of the various ways in which the principles of the invention may be employed. Other objects, advantages and novel features of the invention will become apparent from the following detailed description of the invention when considered in conjunction with the drawings.

### BRIEF SUMMARY OF THE DRAWINGS

FIG. 1 is a view of the dispenser portion of the invention with body shown transparent to reveal internal components.

FIG. 2 is a view of the RCP portion of the invention with body shown transparent to reveal internal components.

FIG. 3 is a view of the invention assembled for use with an alternate embodiment of the applicator component shown as an insert.

### DETAILED DESCRIPTION

The food packaging is composed of an approximately rectangular dispenser with a long longitudinal axis and mostly hollow. One end of the dispenser forms a base and the other end contains a grid on openings through which spreadable foodstuffs exit the dispenser. The base of the dispenser is detachable from the rest of the body of the dispenser. Two screw-spindles are attached to the base and lies along the longitudinal axis of the dispenser when the base and body of the dispenser are attached. Each screw-spindle of the dispenser has a flat member forming an elevator attached and a mechanism is contained within the base such that the elevator member travels along the screw-spindle upon turning of a wheel on the base, a separate wheel for each screw-spindle.

The movement of the elevator members along the longitudinal axis causes spreadable foodstuffs or non-food substances to move through the grid at the end of the body of the dispenser. The movement of the elevator members also causes a decrease in the volume inside the dispenser equal to the volume of contents dispensed. In this manner, air is kept out of contact with the foodstuffs or non-food substances. In an additional embodiment, an electric motor and battery is contained within the base of the dispenser such that the screw-spindle turns upon depressing a button located on the housing of the dispenser and moves the elevator member along the screw-spindle.

The actual products are purchased by a consumer as a refill cartridge product (RCP). The dispenser described above may be sold to consumers with or without RCPs in the dispenser. In either situation, the dispenser is designed for more than one use and may be refilled using said RCPs. The dispenser may be adorned with certain affinity advertising (celebrities, sports teams, movies, etc) and have a longer impact than such advertisements are placed on disposable containers. The shape of the dispenser itself may be shaped to have an affinity or novelty quality (i.e., a baseball bat).

The RCP itself is formed of a body with a size and shape that will tightly fit inside the dispenser when the base of the dispenser is removed. One end of the RCP will have a lid that is removed by the consumer prior to placing in the dispenser. The RCP has rigid material running along the longitudinal axis that divides the RCP into two separate compartments. The other end of the RCP has two plunger members that lie flush against the elevator members of the dispenser when the RCP is sealed inside the dispenser. The each plunger member of the RCP has a hole to accommodate one of the screw-spindles. Upon operating the dispenser, the elevator members of the dispenser presses against and moves the plunger members of the RCP to dispense products. After insertion of a new RCP, the device is ready to dispense again.

The dispenser may be produced with different grids or tops attached to the dispensing end (applicator component), which are suitable for different spreadable foodstuffs, non-food substances and utilities. The applicator component may either be detachable from the body of the dispenser or permanently molded into the body of the dispenser. Specifically, the number, size, and pattern of openings on the dispenser top are optimized based on the viscosity of the product being dispensed.

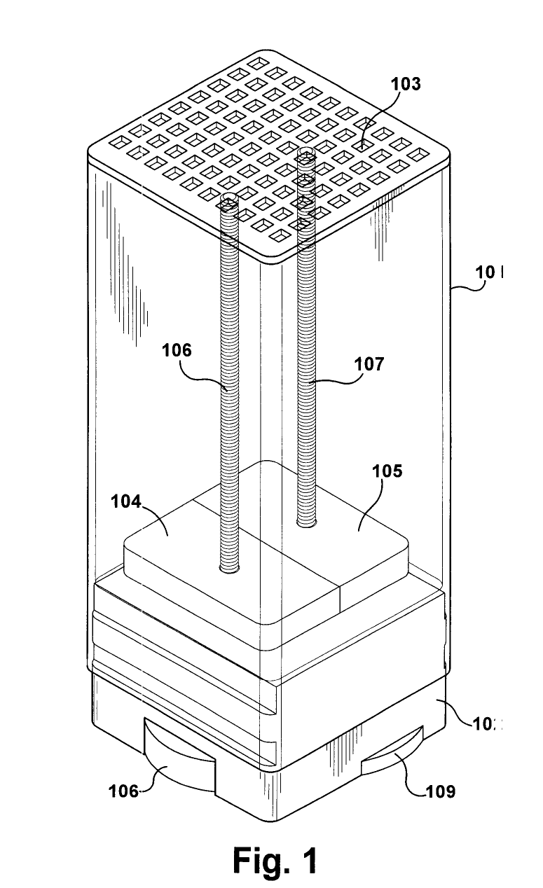

The dispenser of the present invention is depicted in FIG. 1. The body of the dispenser 101 along with the majority of the device is composed of rigid food grade or chemical resistant material. The body of the dispenser 101 can be detached from the base of the dispenser 102. The end of the dispenser opposite from the base has a series of openings 103 that allow for foodstuffs or non-food substances to exit from the dispenser. Attached to the base of the dispenser 102 are two elevator members 104 and 105 and two threaded screw-spindles 106 and 107. Each elevator member 104 and 105 moves along one of the screw-spindles 106 and 107 upon turning wheels 108 and 109 that independently rotate the screw-spindles 106 and 107. Means for accomplishing turning the screw-spindles 106 and 107 are well known in the art. In a second embodiment, the screw-spindles 106 and 107 are powered by an electric motor placed within the base of the dispenser 102. Means for coupling the screw-spindles 106 and 107 with an electric motor are well known in the art. A battery may be placed inside the base and a button for activating the motor may be placed anywhere on the dispenser deemed convenient. The battery may be rechargeable from a DC power source for high use applications such as restaurants.

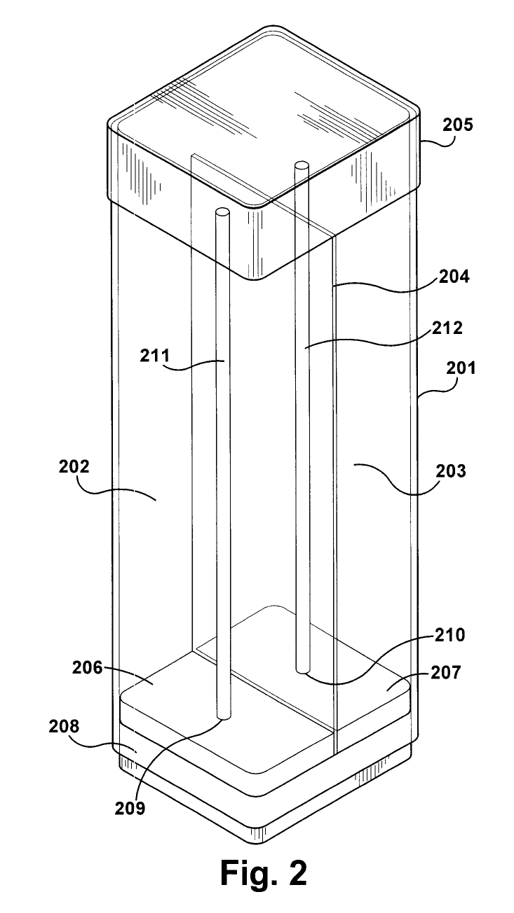

The refill cartridge product (RCP) is depicted in FIG. 2. The body 201 and majority of the RCP is formed of food grade plastic material. The RCP is shaped and designed to fit within the dispenser shown in FIG. 1. The RCP mostly comprises two hollow spaces 202 and 203 which contain the spreadable foodstuff or non-food substance. The two hollow spaces are created via a partition 204. The contents are kept fresh by a lid 205 before the RCP is place in use. The lid 205 may be replaceable such that the RCP may be taken out of the dispenser and stored before the contents are completely consumed. The RCP has two plunger members 206 and 207 and a lip 208 surrounding the bottom of the RCP. The plunger members 206 and 207, the partition 204, and the lip 208 are design such that the elevator members of the dispenser 104 and 105 fit snuggly within the lip 208 and flush against the plunger members 206 and 207. The plunger members 206 and 207 have holes 209 and 210 at the center of each plunger member through which the screw-spindles 106 and 107 may pass. Tubes 211 and 212 may be built into the RCP along the longitudinal axis to prevent the screw spindles from contacting the foodstuff contained in the hollow spaces 202 and 203. The plunger members 206 and 207 fit snuggly against the body 201 of the RCP. Pressure from the elevator members 104 and 105 cause plunger members 206 and 207 to move along the longitudinal axis of the RCP while remaining in tight contact with the body 201 of the RCP.

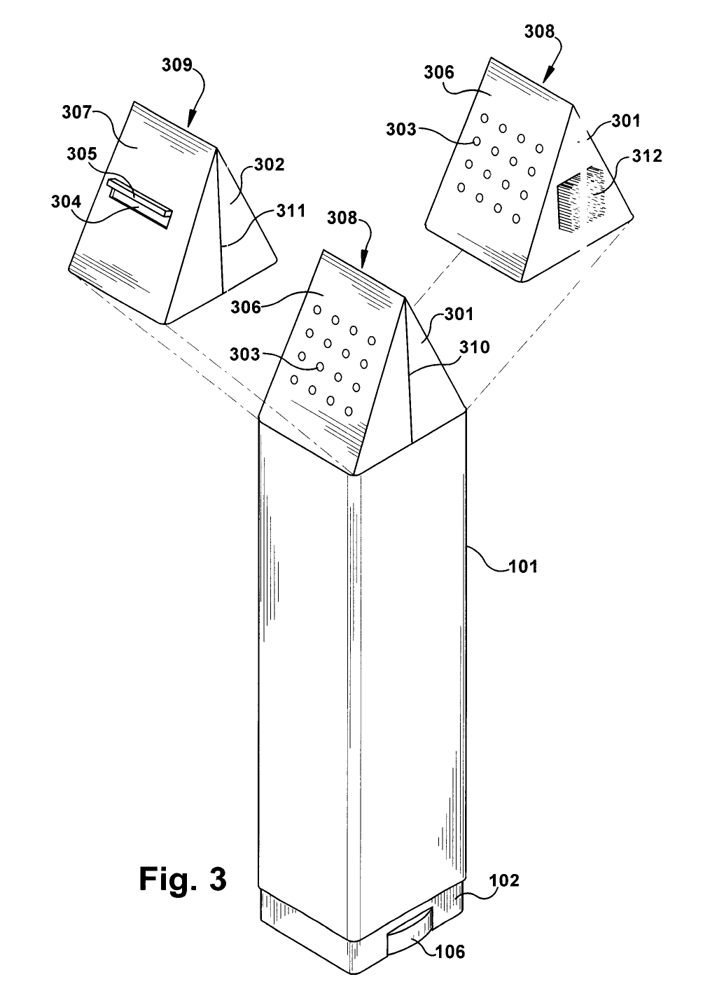

The dispensing end of the dispenser 103 is composed of a series of holes whose diameter is selected based on the consistency and viscosity of the product dispensed. An applicator component may either be detachable from the dispensing end of the dispenser 103 or molded as part of the body 101. If molded as part of the body 101, the grid at the dispensing end 103 may optionally be omitted. The dispensing component 301 or 302, as shown in FIG. 3, has a pyramidal shape with openings 303 or 304. The diameter of the openings is selected based on the consistency or viscosity of the product. Smaller holes 303 are useful for less viscose products such as jelly, ketchup or emollients. A single large hole 304 is appropriate for very viscose products such as peanut butter, cream cheese or shoe polish. For viscose products, an optional lip 305 may be added to assist in detaching the dispensed product from the dispenser. Openings are also located on face 306 and 307 for dispensing product from one chamber of the RCP as well as the opposite faces 308 and 309 for dispensing product from the other chamber of the RCP. The applicator component 301 or 302 is divided by a partition 310 and 311 to keep the two foodstuffs separate during dispensing. A face of the applicator component 306, 307, 308, or 309 is used in a knife-like fashion to spread the foodstuff as desired. A non-stick material is preferably used for the applicator component to aid in easy clean-up after spreading. Additionally, certain applications, such as shoe polish or paints, may benefit from built-in bristles or brushes on the container. Such bristles or brushes 312 may be conveniently placed on the flat surfaces or of the applicator.

While the invention has been explained in relation to certain embodiments, it is to be understood that various modifications thereof will become apparent to those skilled in the art upon reading the specification. Therefore, it is to be understood that the invention disclosed herein is intended to cover such modifications as fall within the scope of the appended claims.

What is claimed is:

1. A dispensing system for spreadable foodstuffs or other non-food substances allowing for storage and dispensing of at least two separate foodstuff and allowing for spreading without additional utensils comprising:
a first container having a longitudinal central axis having an opening for dispensing foodstuff or non-food substance;
a second container having a shape and dimensions to fit within said first container having an opening for dispensing foodstuffs or non-food substance;
wherein said first container further comprises a plurality of screw-spindles arranged along the longitudinal axis of said first container;
elevator members attached to each said screw-spindle; and
wherein said second container further comprises plunger members located opposite said opening for dispensing foodstuffs equal in number to the plurality of said screw-spindles.

2. A dispensing system according to claim 1 wherein said first container further comprises a detachable base to allow for the insertion or removal of said second container.

3. A dispensing system according to claim 1 wherein said screw-spindles are rotated via an electric motor.
